(19) United States
(12) Patent Application Publication
(10) Pub. No.: US 2026/0066592 A1
(43) Pub. Date: Mar. 5, 2026

(54) SWITCHING PLUG CONNECTOR SYSTEM CABLING AND DEVICE CABLING

(71) Applicant: HARTING Electronics GmbH, Espelkamp (DE)

(72) Inventor: Marc GENAU, Lubbecke (DE)

(73) Assignee: HARTING Electronics GmbH, Espelkamp (DE)

(21) Appl. No.: 19/103,669

(22) PCT Filed: Aug. 14, 2023
(86) PCT No.: PCT/DE2023/100592

§ 371 Date: Feb. 13, 2025

(30) Foreign Application Priority Data
Aug. 22, 2022 (DE) 10 2022 121 178.9

(51) Int. Cl. H01R 13/703

(52) U.S. Cl. CPC H01R 13/703

(57) ABSTRACT

To reduce the manual effort and/or staffing involvement required in order to remove an electrical device (41) from an electrically wired device network (41, 42, 43) and/or to insert it therein, it is proposed that switching bridges (33) should be arranged in or on the cable mating connector housing (14) of a cable mating connector (1′).

The invention relates to a switching plug connector system of the type described in the independent claim 1.

Furthermore, the invention relates to a device cabling system comprising a switching plug connector system according to claim 1 and multiple cables.

Switching plug connector systems of this kind are necessary in order to electrically connect to one another and/or disconnect from one another electrical devices, for example, to establish a desired signal flow.

### PRIOR ART

Document DE 195 39 957 A1 discloses a switching plug for an electrical plug connection with a blade contact strip and a spring contact strip. This switching plug comprises a contact mechanism that connects two selected blade elements to one another when the spring contact strip and the blade contact strip are separated from one another, wherein the contact between the selected blade elements is interrupted when the spring contact strip and the blade contact strip are connected.

EP 702 431 A2 discloses a switching plug for a strip connector on printed circuit boards, particularly on data bus boards. This switching plug includes a plurality of sockets for receiving a blade contact strip. The socket strip contains at least two associated contact elements per socket, which form a short-circuit bridge between the sockets as long as no blade contact is inserted. In this case, inserting the blade contact strip and thereby expanding the elements that receive the blade contacts results in an interruption of the short-circuit bridge. The short-circuit bridge is established either through direct contact between the sockets or via a contact insert embedded in the base body supporting the socket strip.

A disadvantage of this prior art is that the arrangements known therein fail to meet many of the currently existing requirements. In particular, in industrial environments, control systems, digital server stations, laboratories, research facilities, and many other installations and setups, for example, it is common practice to arrange electrical devices in racks, for example, and typically wire them “on the fly” at the rear of the respective devices. For instance, a device plug belonging to the electrical device may be particularly arranged on the aforementioned rear side of the device and, for its part, be electrically connected on its connection side, e.g. to a circuit board of the respective electrical device. On its plug side, it can then be electrically connected via a cable mating connector, to which at least one electrical cable is attached, to other electrical devices in the system, for example, to enable signal transmission. In particular, at least two cables, in particular exactly two cables, may be connected to the cable mating connector. If one of these electrical devices is removed from the system, the wiring must currently also be modified, which is a disadvantage.

Rewiring not only creates an undesirably high manual workload, but also a new source of potential faults, e.g. due to human error, such as through inattention, and/or lack of knowledge, possibly caused by poor documentation, etc. In addition, this process involves high personnel costs, because a competent individual must perform, or at least oversee, the rewiring.

### OBJECT

The object of the invention is to reduce the manual effort and/or staffing involvement required in order to remove an electrical device from an electrically wired device network and/or to insert it therein.

This object is achieved by the subject matter of the independent claims in each case.

An electrical switching plug connector system comprises at least one device plug connector which includes a connection housing for attachment in, or on, an electrical device. On the connection side, the device plug connector has multiple device terminals, and on the plug side, it has multiple mating contacts each electrically connected to a respective device terminal.

Furthermore, the electrical switching plug connector system includes at least one cable mating connector that can be plugged into the device plug connector in a plug-in direction. This cable mating connector has a cable mating connector housing which has at least one cable outlet. In addition, the cable mating connector has multiple mating contacts, each of which can be plugged into a respective mating contact of the device plug connector on the plug-in side, thereby establishing an electrical connection to the corresponding mating contact of the device plug connector. On the connection side, each of the mating contacts has a cable terminal.

The switching plug connector system has at least one electrically conductive switching bridge.

This at least one switching bridge is at least partially arranged in or on the cable mating connector housing of the cable mating connector, in order to electrically connect two of the mating contacts of the cable mating connector to one another in an electrically conductive manner when in the unmated state.

In this context, the term “plug-in direction” refers to the direction of the plugging-in process as a mathematical motion vector, but not to the orientation of the motion vector.

A particular advantage of the invention is that the cables connected to the respective cable terminals of the two mating contacts, which are electrically connected to one another via the switching bridge, are electrically conductively connected to one another in the unmated state.

A particularly significant advantage of the invention is that an electrical device can be removed from the network without requiring subsequent changes to the wiring. In particular, depending on the signal configuration, the signals that have passed through the removed electrical device, particularly according to a specified data transfer protocol, can now be simply routed within the cable mating connector from one cable to another and thereby transmitted to the next device in the chain.

Through smart, one-time planning of the wiring, switching bridges, and cable assignments, various functionalities can be implemented within a device network in this manner.

In a preferred embodiment, the electrical switching plug connector system is designed to interrupt the aforementioned electrical connection between the two respective mating contacts when in the mated state.

The aforementioned two mating contacts are therefore galvanically isolated in the mated state.

In a preferred embodiment, the switching bridge is made of an electrically conductive material, in particular metal, e.g. sheet metal. The switching bridge may therefore be a stamped and bent part.

The cable mating connector housing and/or the cable mating connector housing may be made of an electrically insulating material, e.g. plastic or ceramic.

In a preferred embodiment, the cable mating connector housing has at least two cable openings. This allows the cable terminal plug connector to be connected, in addition to the first electrical device to which it is plug-connected on the device side, to two additional electrical devices on the cable connection side, namely to a second electrical device with a second device plug connector and a third electrical device with a third device connection plug. This connection can preferably be established via a second and a third cable connection plug, each of which is plugged into the second and third device connection plugs, respectively. This design enables very flexible construction, modification, and, in particular, easy expansion of device networks for additional fourth, fifth, sixth,. or n devices without significant effort.

In a further preferred embodiment, the at least one plug-in contact of the device plug connector may be a blade contact.

In another preferred embodiment, the mating contacts of the cable mating connector may be designed as fork contacts. Consequently, they each have two spring-loaded contact tongues, which are specifically designed to electrically and mechanically contact the aforementioned plug contact on both sides.

In a preferred embodiment, the at least one switching bridge, that is, each of the aforementioned switching bridges, can be arranged at least partially between two contact tongues of two mating contacts.

For example, this may mean that the mating contacts are arranged and configured in such a manner that, for each pair of contact tongues, an outer contact tongue-relative to the other pair of contact tongues-contacts the switching bridge in the unmated state, so that these two mating contacts are automatically electrically connected to one another in the unmated state and automatically disconnected from one another in the mated state. In the mated state, the two outer contact tongues are bent outwards by the insertion of the respective blade contact. This electrically separates the two mating contacts. For this kind of arrangement, a switching bridge with a substantially flat geometric shape is sufficient. In this case, the switching bridge can even be arranged entirely-and not just partially-between the two aforementioned outer contact tongues.

However, the aforementioned embodiment also encompasses an arrangement in which at least one switching bridge is, for example, bent into a U-shape and positioned with its ends between the two contact tongues of each pair of contact tongues, mechanically and electrically contacting both contact tongues of each pair. This improves the conductivity of the connection in the unmated state, meaning that the electrical conductivity between the two mating contacts in the unmated state can be approximately twice as high as in the previously mentioned variant, as the effective contact area is roughly doubled. In this case, the contact tongue is only partially arranged between the two outer contact tongues.

In a preferred development, the cable mating connector has at least one part that is movable relative to the mating contacts and holds at least one switching bridge.

This means that the cable connector can have one, but also multiple, movable parts of this kind. On this movable part/on each of these movable parts, at least one of the aforementioned switching bridges is held. This may therefore involve one or also multiple, e.g. 2, 3, 4, 5, 6 . . . , or n switching bridges.

In a preferred embodiment, a single movable part can therefore be arranged within the cable mating connector housing, wherein only one switching bridge is held on this movable part. This is, for example, suitable for single-pole signal or power transmission. This switching bridge can be moved relative to the mating contacts, electrically contacting them to create a conductive connection between the contacts in the unmated state, or disconnecting this connection in the mated state. During the plugging process, the device plug connector can move the movable part in such a manner that the electrical connection between the two respective mating contacts is interrupted. When the plug connection is unplugged again, the movable part returns to its initial position, and the electrical connection between these two mating contacts is re-established.

There may be a single movable part that holds multiple switching bridges, e.g. 2, 3, 4, 5, . . . n switching bridges.

There may also be multiple movable parts in the cable mating connector housing, each movable part holding only one switching bridge.

Another option, however, is for the cable mating connector housing also to include multiple movable parts, on each of which multiple, but not all, switching bridges are arranged.

During the plugging process, the movable part, and therefore also the switching bridges held on it, can move away from the mating contacts, particularly when spring-loaded. This movement can occur in a separation direction. The separation direction may, for example, run parallel to the plugging direction, such as when the movable part has a sliding mechanism. Alternatively, the separation direction can run perpendicular to the plugging direction, such as when the movable part is designed as a rocker and/or a lever. Consequently, the at least one switching bridge held on the movable part can be spring-loaded and moved away from the respective mating contacts in the separation direction when the cable mating connector is plugged into the device plug connector. This may correspond to the process described above, wherein the electrically conductive connection between the two mating contacts is interrupted.

The term “removable” in this case is also intended to mean that the distance from the respective mating contacts increases due to the “removal” process. This device therefore also has the advantage of enabling particularly large air gaps between the switching bridges and the mating contacts, making it particularly suitable for high-voltage applications. Hybrid forms are also conceivable, in which the electrical disconnection is achieved through deformation of the mating contacts, while the desired air gaps and/or creepage distances are primarily created by the movement of the movable part.

In a preferred embodiment, the movable part may have at least one spring element. This spring element can be integrally formed with the movable part, for example, particularly if the movable part is made of a plastics material with sufficient elasticity. This approach has the advantage of being easy to manufacture. Additionally, the spring element can exert a particularly advantageous force vector, depending on the overall arrangement. Alternatively or additionally, at least one spring element may be attached to the movable part. This spring element may be a separate component, such as a metallic coil spring. This has the advantage that the material of the movable part does not need to possess the elasticity required for the spring properties.

This development is therefore fully compatible with the aforementioned embodiment, in which at least one switching bridge is at least partially arranged between two contact tongues of two mating contacts.

Finally, the aforementioned increase in the distance between the switching bridge and the respective contact also offers the advantage of a particularly large air gap. This can also be beneficial in addition to the aforementioned design.

For low-profile designs, it is advantageous for the separation direction to align with the plugging direction, as this allows for better utilization of the space available within the cable mating connector housing. This may become important when multiple device plug connectors are arranged in a confined space.

If the separation direction runs perpendicular to the plugging direction, this can be advantageous because its wear on the fork contacts is thereby reduced.

In another advantageous embodiment, the at least one switching bridge can have two contact surfaces opposite one another.

In the unmated state, these contact surfaces can electrically and mechanically contact each of the two contact tongues of each of the two mating contacts it connects, in that each of its two contact surfaces lying opposite one another can mechanically and electrically contact one of the two contact tongues of each mating contact.

In particular, the switching bridge may have a substantially flat design.

The switching bridge may be realized as a one-piece stamped part or stamped-bent part and is preferably made of sheet metal.

In a preferred embodiment, each of the two contact tongues of the two mating contacts electrically connected by the switching bridge can have a switching contact section, which electrically and mechanically contacts the respective switching bridge in the aforementioned unmated state.

A device wiring system is, for example, suitable for electrically connecting at least three, and in particular also more than three, so for example also 4, 5, 6, 7, . . . , n electrical devices, but at least, as already mentioned, three devices, namely a first, a second, and a third electrical device.

In this case, the device wiring system comprises multiple electrical cables, as well as a switching plug connector system of the aforementioned kind. At least one of the device plug connectors belongs to the first electrical device, meaning that it is, for example, fastened to or within the first electrical device with its connection housing and is electrically connected to the electrical device via its device terminals, e.g. to electrical conductors on a circuit board within the electrical device.

The cable mating connector plugged into the first device plug connector is electrically connected, or at least connectable, to the second and third electrical devices via at least one of the electrical cables in each case. This can be particularly achieved through additional device plug connectors and cable connection plugs on the respective electrical devices.

Through this connection, in the mated state, the first electrical device is therefore automatically electrically connected to both the second and third electrical devices. In contrast, in the unmated state, the second and third electrical devices are automatically electrically connected to each other and automatically electrically disconnected from the first electrical device. Finally, in the unmated state, the switching bridges already electrically connect the two cables attached to the respective mating contacts within the cable connector.

As already indicated, the device wiring described here for only three electrical devices can be extended to accommodate any arbitrary number of possible electrical devices.

Advantageous embodiments of the invention are specified in the dependent claims and the following description.

### EXEMPLARY EMBODIMENT

Several exemplary embodiments of the invention are illustrated in the drawings and are explained in greater detail below. In the drawings:

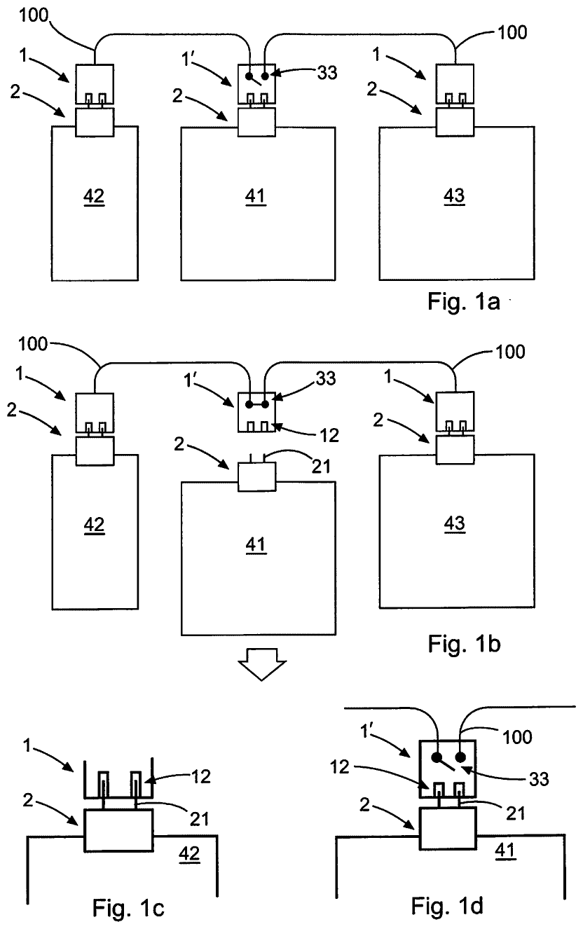

FIGS. 1a-d: show three electrical devices with a device wiring system;

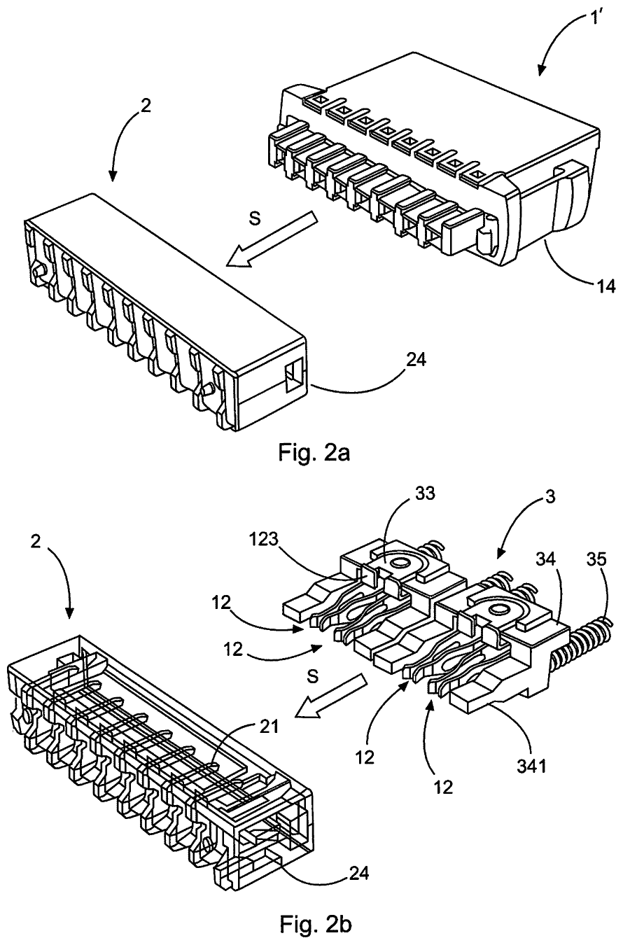

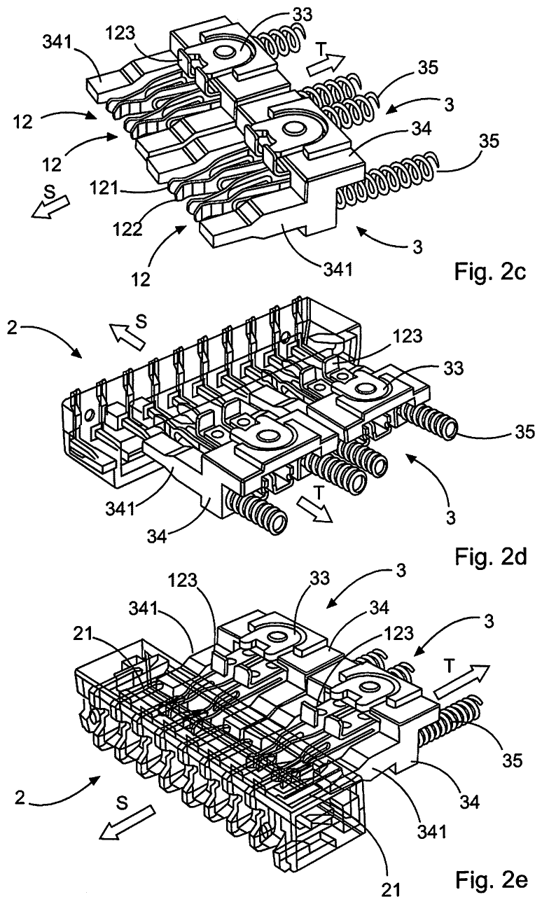

FIGS. 2a-e: show a plug connector system in a first embodiment;

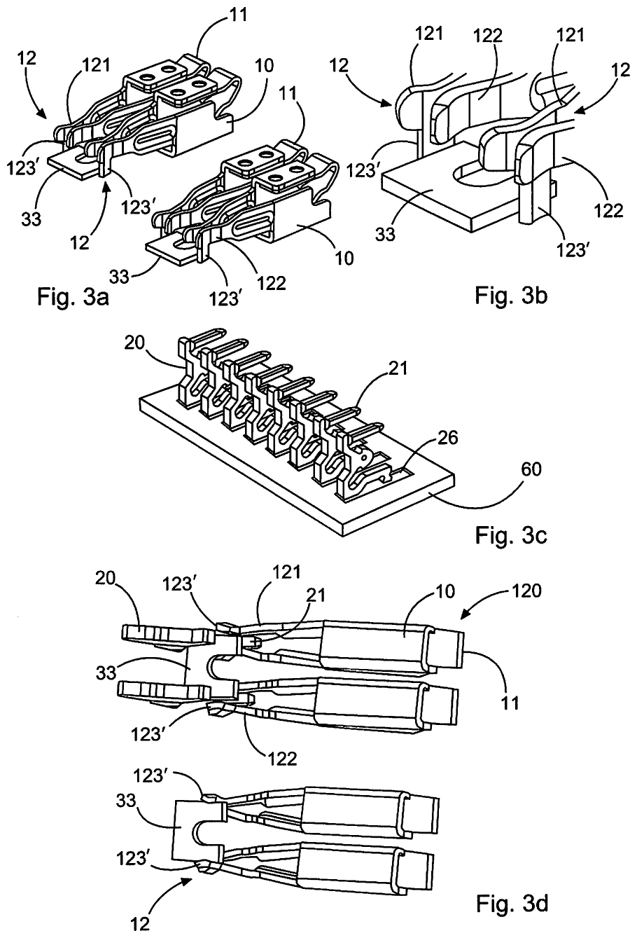

FIGS. 3a-d: show a plug connector system in a second embodiment;

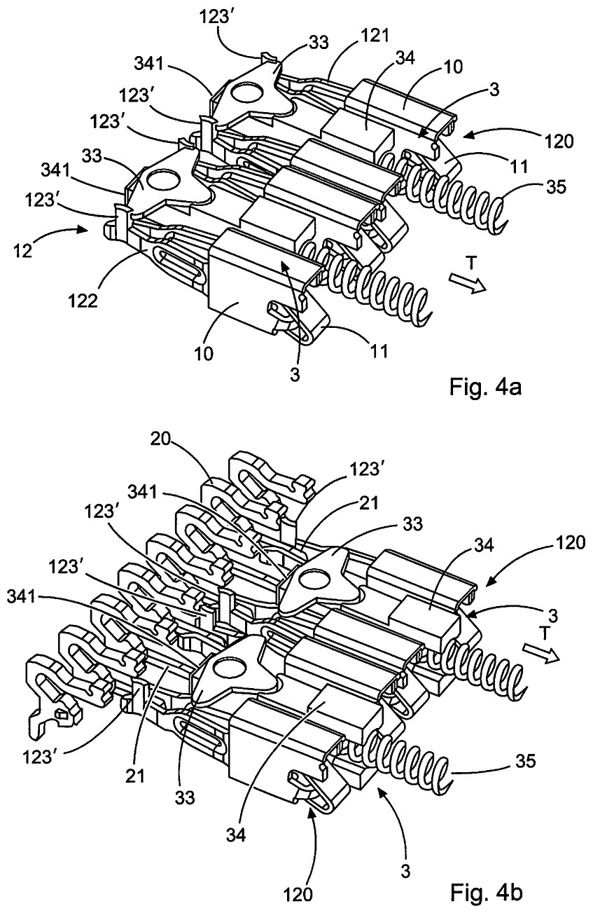

FIGS. 4a-b: show a plug connector system in a third embodiment;

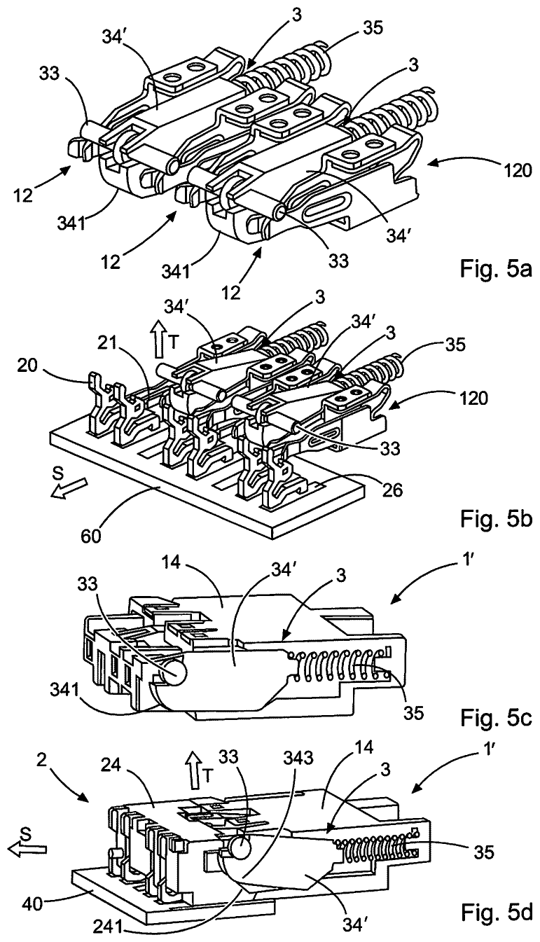

FIGS. 5a-d: show a plug connector system in a fourth embodiment;

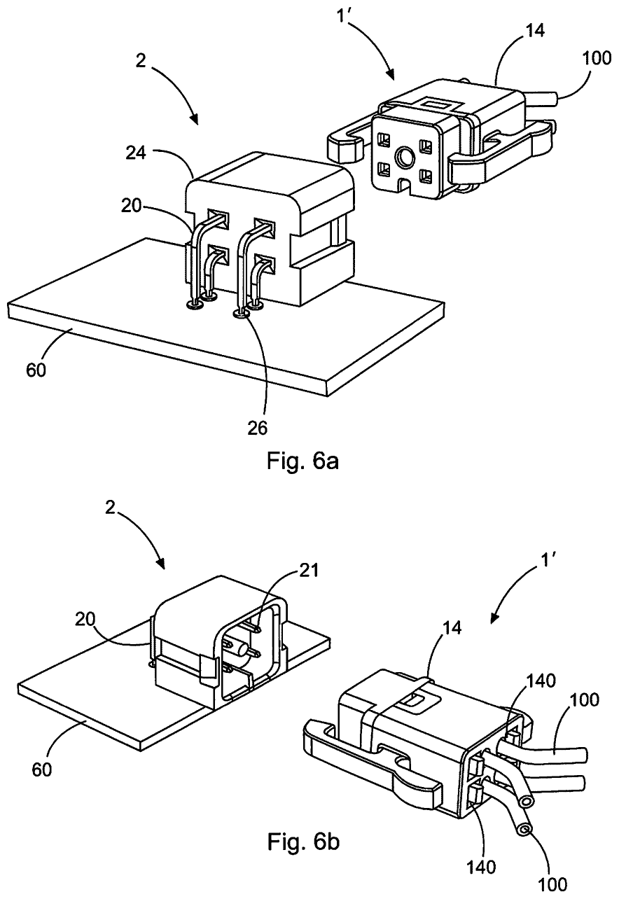

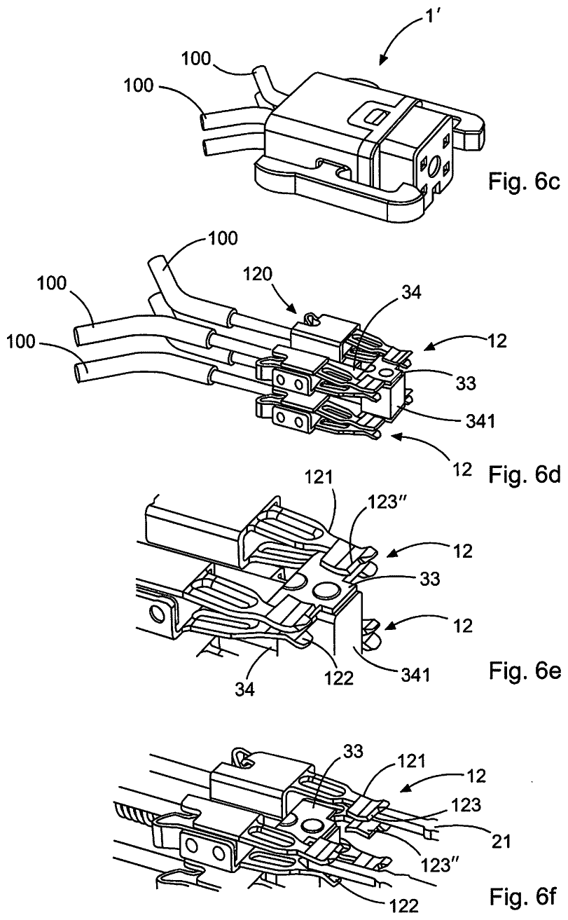

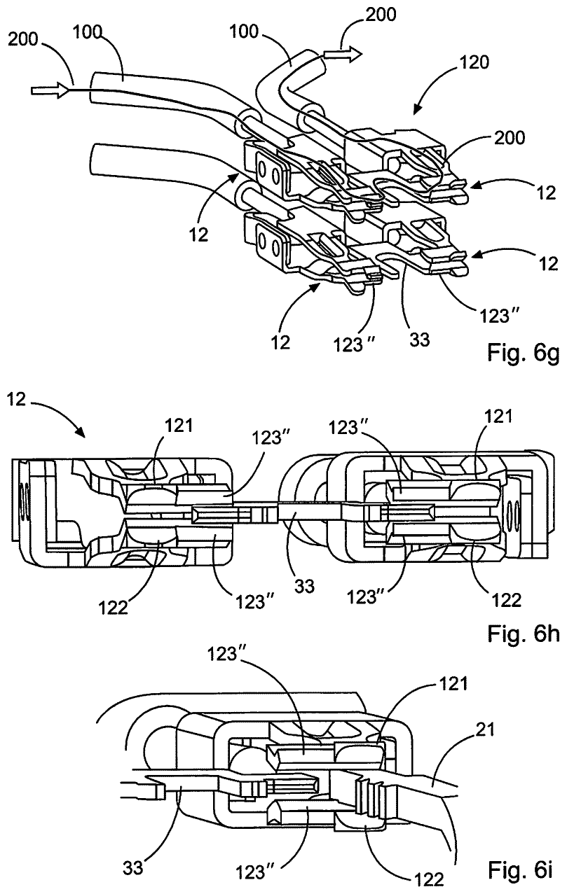

FIGS. 6a-i: show a plug connector system in a fifth embodiment.

The figures contain partially simplified, schematic representations. In some cases, identical reference signs are used for elements that are the same but not necessarily identical. Different views of the same elements may be shown in different scales. Directional indications such as “left,” “right,” “top”, and “bottom” are to be understood in relation to the respective figure and may vary in the individual representations in relation to the object depicted.

FIG. 1a shows a device wiring system comprising multiple cables 100 and multiple cable connectors 1, 1′, one cable connector 1′of which contains a switching bridge 33. Three electrical devices 41, 42, 43 are also depicted, namely a first device 41, a second device 42, and a third device 43. Each of these devices 41, 42, 43 is equipped with a device plug connector 2 that is electrically connected on the terminal side to the electronics of the respective electrical device 41, 42, 43.

Each device connector 2 is mated with one of the cable connectors 1, 1′in the device wiring system.

In the cable mating connector 1′depicted in the center, the aforementioned switching bridge 33 is open. This cable mating connector 1′is connected via a cable 100 to one of the other two cable connectors 1 in each case. As a result, the second electrical device 42 is connected to the first electrical device 41 (shown in the center) via the device wiring. Similarly, the third electrical device 43 is connected to the first electrical device 41 via the device wiring. However, the second electrical device 42 and the third 43 electrical device are not directly connected to one another but may only be connected through the first electrical device 41, provided that the first electrical device 41 is designed to establish the signal flow between these two additional electrical devices 42, 43.

FIG. 1b shows how the device plug connector 2 of the first electrical device is disconnected from the cable mating connector 1′. The switching bridge 33 closes automatically and the other two electrical devices 42, 43 are thereby automatically electrically connected to one another via the device wiring.

FIGS. 1c and 1d show enlargements from FIG. 1a and are provided solely for clarity.

As shown in FIG. 2a, the cable mating connector 1′has a cable mating connector housing 14 and can be mated with the device plug connector 2 in a mating direction S. The device plug connector 2 includes a device plug connector housing 24.

In FIG. 2b, the device plug connector housing 24 is shown as transparent, and the cable mating connector housing 14 is removed. This provides a view of the mating contacts 12 of the cable mating connector 1′, which can mate with the mating contacts 21 of the device plug connector in the mating direction S. The orientation of the arrow for the mating direction S is chosen from the subjective perspective of the cable mating connector in this case; the reference designation S represents the direction of movement, not the orientation of the movement vector.

In this case, as well as in FIG. 2c, the cable connector 1′is shown without the housing 14 from various perspectives. At least one movable part 3 of the cable connector 1′is depicted here. This movable part 3 includes a slider 34 with an actuation section 341 that interacts with the device plug connector 2 during the mating process. In addition, the cable mating connector includes at least one spring element 35, in this case, four separate spring elements 35, which are implemented as coil springs.

In another alternative embodiment, which is hereby explicitly disclosed as part of the invention, the spring elements may be integrally formed on the movable part, particularly on the slider. For this purpose, the slider may be made of a sufficiently elastic plastic, and the elasticity of the spring element may also be achieved through its design.

Each slider 34 has a switching bridge 33 fastened to it.

In the unmated state, this switching bridge, due to the spring force of the spring elements, presses against switching contact sections 123 of the mating contacts 12 that are to be electrically connected/bridged.

FIGS. 2d and 2e show the device plug connector 2 and the cable connector 1′in the mated state. In this case, contact pins 21 that are not needed for power transmission, for example, press against the actuation sections 341 and push the respective sliders 34 against the spring force in a separation direction T away from the device plug connector. In this case, the switching bridge 33 is separated from the switching contact sections 123.

Consequently, the bridging is automatically removed in the mated state. In this process, the separation direction T runs parallel to the mating direction S.

FIGS. 3a to 3d illustrate a second embodiment of the connector system.

Each mating contact has two contact tongues 121, 122, one pair of which (namely, the two furthest-apart contact tongues 121, 122) are electrically connected in the unmated state via the contact bridge 33 which, in this case, is implemented as a flat component. For this purpose, each of these two outer contact tongues 121, 122 includes a switching contact section 123′. The contact bridge 33 in this case is arranged at least partially between these two contact tongues 121, 122, specifically between the switching contact sections of the two contact tongues 121, 122.

During the mating process, these two outer contact tongues 123′are pushed apart by the mating contacts 21 of the device plug connector 2. This action breaks the electrical connection to the switching contact sections 123′and thereby lifts the electrical bridge.

The contact pins 21 of the device connector 2 are part of a device terminal 20, consisting of metallic contact elements. The device terminal includes a circuit board terminal for soldering onto a circuit board 60 belonging to the respective electrical device 41, as shown in FIG. 3c.

FIG. 3d further illustrates the non-bridged state when mated and the bridged state when disconnected. It is noticeable here that, in the non-bridged state, the distance between the two outer contact tongues and the contact bridge 123′is extremely small.

In addition, the cable connection 120 of the mating contacts 12 is shown here for the first time. It has a cage-shaped busbar 10 and a V-shaped clamping spring 11.

FIGS. 4a and 4b show a third embodiment that represents a synthesis of the first and second embodiments. As in the aforementioned second embodiment, here too, the outer contact tongues 121, 122 are bridged in the unmated state by the contact bridge 123′and in the mated state, are moved outwards by the mating contacts 21 of the device plug connector 2, thereby removing the bridge.

However, due to the very small distances, the required air gaps cannot yet be maintained in this way, at least for high electrical voltages, as already mentioned in the previous exemplary embodiment. To address this issue, as shown in the first exemplary embodiment, the respective contact bridge 123′is mounted on the slider 34. In this case, however, a separate slider 34 is provided for each contact bridge 123.

The cable connection 120, comprising the cage-shaped busbar 10 and the V-shaped clamping spring 11, is also more clearly visible in these depictions. Here, too, the separation direction T runs parallel to the mating direction S.

In a fourth exemplary embodiment, shown in FIGS. 5a to 5d, the movable part 3 includes a rocker 34′. Due to the spring force of the spring element 35, the contact bridge 33 held on the rocker 34′is pushed downwards in the unmated state in the drawing, thereby connecting two adjacent mating contacts 12, respectively.

During the mating process, however, a sliding ramp 343 on the rocker 34 slides along a ramp 241 of the device connector housing 24, thereby lifting the contact bridge 33 upwards in the drawing against the spring force and consequently moving away in the separation direction T from the mating contacts 12. In this case, the separation direction T is perpendicular to the mating direction S.

FIGS. 6a to 6i show a fifth exemplary embodiment.

FIGS. 6a and 6c show the device connector 2 and the cable connector 1′, including their housings 24 and 14.

The device plug connector 2 is soldered to the circuit board 60 via its device terminals 20, each of which ends in a circuit board connection 26. The device terminals are integrally formed with the mating contacts 21.

The cable mating connector 1′has, in this example, four cable openings 140 through each of which a cable 100 is routed.

FIGS. 6d to 6f illustrate a concept that deviates from the second exemplary embodiment in the following way: Each of the contact tongues 121, 122 involved has a switching contact section 123″. The contact bridge 33 is electrically connected on both sides between the switching contact sections 123″ of the contact tongues 121, 122 of a cable connection 120. In addition, as mentioned in the previous example, the contact bridge 33 is mounted on the slider 34. During the mating process, the two contact tongues 121, 122 of both mating contacts 12 involved are first pushed apart from one another by the mating contact 21 of the device plug connector 2, thereby releasing the contact bridge 33. Furthermore, the slider 34 is displaced by the mating contact in such a way that the contact bridge 33 moves further away from the mating contacts 12.

In FIGS. 6g to 6i, the initial separation process is once again clarified in a front view.

FIG. 6g shows the electrical current flow 200 through two cables 100, two mating contacts 12 bridged by the contact bridge 33, and the contact bridge 33 itself.

On the cable connection side, the stripped cables 100 are inserted into their respective cable connections 120 using a push-in technique.

FIG. 6h shows the two mating contacts 12 in the unmated state, with their contact tongues 121 electrically and mechanically contacting the contact bridge 33 on both sides via their switching contact sections 123″.

FIG. 6i depicts the mated state, in which the two contact tongues 121, 122 are pushed apart by the mating contact 21 of the device plug connector 2. As a result, the corresponding switching contact sections 123″ lose their mechanical and electrical contact with the contact bridge 33 and release it. The electrical current/signal flow 200 shown in FIG. 6g is thereby interrupted.

### LIST OF REFERENCE SIGNS

1, 1′cable mating connector
10 (cage-shaped) busbar
11 clamping spring
12 mating contacts, fork contacts
120 cable connection
121, 122 contact tongues
123, 123′, 123″ switching contact sections
14 cable mating connector housing
140 cable opening
2 device plug connector
20 device terminal
21 mating contact, blade contact, contact pin
24 device plug connector housing
243 ramp
26 circuit board connection
3 movable part
33 contact bridge
34, 34′slider, rocker
343 sliding ramp
35 spring element
41, 42, 43 electrical device
6 circuit board
100 cable
200 electrical current flow
S mating direction
T separation direction

1. An electrical switching plug connector system, comprising the following:
at least one device plug connector (2) which includes the following:
a connection housing (24) for attachment in, or on, an electrical device (41, 42, 43),
on the connection side, multiple device connections (20), and
on the plug side, multiple mating contacts (21) each electrically connected to a respective device terminal (20); and also
at least one cable mating connector (1′) that can be plugged into the device plug connector (2) in a plug-in direction(S) which includes the following:
a cable mating connector housing (14) which has at least one cable outlet (140),
multiple mating contacts (12), each of which can be plugged into a respective mating contact (21) of the device plug connector (2) on the plug-in side, thereby establishing an electrical connection to the corresponding mating contact (21) of the device plug connector (2), wherein
on the connection side, each of the mating contacts (12) has a cable terminal (120), wherein the switching plug connector system has at least one electrically conductive switching bridge (33), wherein
the at least one switching bridge (33) is at least partially arranged in or on the cable mating connector housing (14) of the cable mating connector (1′), in order to electrically connect two of the mating contacts (12) of the cable mating connector (1) to one another in an electrically conductive manner when in the unmated state.

2. The electrical switching plug connector system as claimed in claim 1, wherein the electrical switching plug connector system is designed to interrupt the aforementioned electrical connection between the two respective mating contacts (12) of the cable mating connector by the switching bridge (33) when in the mated state.

3. The electrical switching plug connector system as claimed in claim 1, wherein the cable mating connector housing (14) has at least two cable openings (140).

4. The electrical switching plug connector system as claimed in claim 1, wherein the at least one plug contact (21) of the device plug connector (2) is a blade contact or a contact pin.

5. The electrical switching plug connector system as claimed in claim 4, wherein the mating contacts (12) of the cable mating connector (1′) are designed as fork contacts and therefore each have two spring-loaded contact tongues (121, 122) which are designed to electrically and mechanically contact the aforementioned plug contact (21) on both sides.

6. The electrical switching plug connector system as claimed in claim 5, wherein the at least one switching bridge (33) is arranged at least partially between two contact tongues (121, 122) of two mating contacts (12), in order to electrically connect these two mating contacts (12) to one another in the unmated state and to disconnect them from one another in the mated state.

7. The electrical switching plug connector system as claimed in claim 1, wherein the at least one cable mating connector (1′) has at least one part that is movable (3) relative to the mating contacts (12) and holds at least one switching bridge (33).

8. The electrical switching plug connector system as claimed in claim 7, wherein the at least one switching bridge (33) held on the movable part (3) can be spring-loaded and moved away from the mating contacts in the separation direction (T) when the cable mating connector (1′) is plugged into the device plug connector (2).

9. The electrical switching plug connector system as claimed in claim 7, wherein the separation direction runs parallel to the mating direction(S).

10. The electrical switching plug connector system as claimed in claim 7, wherein the separation direction (T) runs perpendicular to the mating direction(S).

11. The electrical switching plug connector system as claimed in claim 7, wherein the movable part (3) has at least one spring element or at least one separate spring element (35) is arranged on the movable part (3).

12. The electrical switching plug connector system as claimed in claim 4, wherein the at least one switching bridge (33) has two contact surfaces opposite one another, wherein in the unmated state, the switching bridge (33) is in electrical and mechanical contact with the two contact tongues (121, 122) of each of the two mating contacts (12) it electrically connects, in that each of the two contact surfaces of the switching bridge (33) lying opposite one another can mechanically and electrically contact one of the two contact tongues (121, 122) of each mating contact (12).

13. The electrical switching plug connector system as claimed in claim 12, wherein the switching bridge (33) has a substantially flat design.

14. The electrical switching plug connector system as claimed in claim 1, wherein the switching bridge (33) is realized as a one-piece stamped part or stamped-bent part and is made of sheet metal.

15. The electrical switching plug connector system as claimed in claim 12, wherein, in the unmated state, each of the two contact tongues (121, 122) of the two mating contacts (12) electrically connected by the switching bridge (33) has a switching contact section (123′), which electrically and mechanically contacts the respective switching bridge (33).

16. The electrical switching plug connector system as claimed in claim 1, wherein the aforementioned cable connection (120) of the respective mating contact (12) has a cage-shaped busbar (10) and a substantially V-shaped clamping spring (11).

17. A device wiring system, suitable for electrically connecting three electrical devices, namely a first electrical device (41), a second electrical device (42), and a third electrical device (43), wherein the device wiring system comprises multiple electrical cables (100), as well as a switching plug connector system according to claim 1, wherein at least a first (1′) of the device plug connectors belongs to the first electrical device (41), wherein the cable mating connector (1′) is electrically connectable to the second electrical device (42) and the third electrical device (43) via at least one of the electrical cables (100) in each case, so that in the mated state with the first device plug connector (1′), the first electrical device (41) is automatically electrically connected to both the second electrical device (42) and the third electrical device (43), and in the unmated state, the second electrical device (42) and the third electrical device (43) are automatically electrically connected to one another and automatically electrically disconnected from the first electrical device (41).
